(19) United States
(12) Patent Application Publication
(10) Pub. No.: US 2026/0255092 A1
(43) Pub. Date: Aug. 27, 2026

(54) SPEAKER AND ELECTRONIC DEVICE

(71) Applicant: Honor Device Co., Ltd., Shenzhen (CN)

(72) Inventors: Jiaze Huang, Shenzhen (CN); Chuanguo Wang, Shenzhen (CN); Wei Liu, Shenzhen (CN); Qifan Bai, Shenzhen (CN)

(21) Appl. No.: 18/995,450

(22) PCT Filed: Apr. 27, 2023
(86) PCT No.: PCT/CN2023/091074

§ 371 Date: Jan. 16, 2025

(30) Foreign Application Priority Data
Aug. 1, 2022 (CN) 202210914268.0

(51) Int. Cl. H04R 1/02; H04R 1/34

(52) U.S. Cl. CPC H04R 1/025; H04R 1/345; H04R 2499/11

(57) ABSTRACT

This application discloses a speaker and an electronic device, including: a first housing with a sound outlet channel; a second housing connected to the first housing; and a speaker unit. After the speaker unit is connected to the first housing, a front cavity and a rear cavity are formed, where the front cavity is connected to the sound outlet channel, and the rear cavity is a sealed cavity. The raw material components of the first housing and the second housing include 50-90 wt % of a polymer composite material and 10-50 wt % of a hollow sphere material. 10-50 wt % of the hollow sphere material is added to the raw material components of the first housing and the second housing.

### CROSS-REFERENCE TO RELATED APPLICATIONS

This application is a national stage of International Application No. PCT/CN2023/091074, filed on Apr. 27, 2023, which claims priority to Chinese Patent Application No. 202210914268.0, filed on Aug. 1, 2022, both of which are incorporated herein by reference in their entireties.

### TECHNICAL FIELD

This application belongs to the field of electronic device technologies, and in particular, relates to a speaker and an electronic device.

### BACKGROUND

Currently, electronic devices such as a personal computer, a tablet, and a mobile phone all have a sound playing function, and a component configured to implement the sound playing function is a speaker. Generally, the speaker includes a housing and a speaker unit, where the speaker unit is a core component configured to form an outgoing sound, and the housing is configured to provide a sound cavity for the speaker unit, to implement corresponding acoustic performance. The housing of the speaker is formed by welding two parts of the housing.

A material of the housing in the speaker is usually prepared by using plastic particles. Currently, to meet good welding performance, the plastic particles are made of a polymer composite material composed of PC (polycarbonate) and glass fibers. However, a density of the plastic particles formed by the polymer composite material is relatively large, resulting in relatively large mass of a prepared housing.

Therefore, a housing material prepared by using the polymer composite material composed of the PC (polycarbonate) and the glass fibers cannot meet a current requirement for reducing a weight of an electronic device.

### SUMMARY

To resolve a problem that in a conventional technology, a housing material cannot meet a current requirement for reducing a weight of an electronic device, this application provides a speaker and an electronic device.

According to a first aspect, this application provides a speaker, including: a first housing, where a sound outlet channel is disposed on the first housing; a second housing, where the second housing is snap-fit connected to the first housing, to form a first cavity; and a speaker unit, where the speaker unit is disposed in the first cavity, and after the speaker unit is connected to the first housing, the first cavity is divided into a front cavity and a rear cavity, where the front cavity is connected to the sound outlet channel, and the rear cavity is a sealed cavity; and raw material components of the first housing and the second housing include 50-90 wt % of a polymer composite material and 10-50 wt % of a hollow sphere material in terms of mass percentage.

In this way, 10-50 wt % of the hollow sphere material is added to the raw material components of the first housing and the second housing, so that densities of the first housing and the second housing can be reduced, thereby reducing weights of the first housing and the second housing.

In a possible implementation, an energy director is disposed on the second housing, and when used for welding, the energy director forms a surface contact with the first housing; and when the second housing is subjected to high-frequency vibration, the energy director and the first housing rub against each other on a contact surface to generate heat, so that the first housing and the second housing are welded together.

In this way, by changing a shape of the energy director, a contact area between the energy director and the first housing is increased. In this way, in a welding process, more energy can be generated, to ensure welding reliability. Therefore, this application may be compatible with different characteristics of a plurality of types of polymer materials, for example, a crystalline polymer material and a semi-crystalline polymer material, so that the speaker provided in this embodiment of this application can meet a reduction requirement of the speaker and can ensure welding reliability.

In a possible implementation, a cross section of the energy director is trapezoidal, rectangular, or W-shaped.

In this way, by changing the shape of the energy director, the contact area between the energy director and the first housing is increased. In this way, in the welding process, more energy can be generated, to ensure welding reliability.

In a possible implementation, an outer surface of the energy director is roughened.

In this way, roughening processing is performed on the outer surface of the energy director, to increase roughness of the outer surface of the energy director. In this way, the energy director with increased surface roughness is more conducive to generating heat for welding by rubbing against the first housing. A surface roughening processing manner is not limited in this application. For example, a concave-convex texture may be disposed on the outer surface of the energy director. For another example, concave-convex particles may be disposed on the outer surface of the energy director.

In a possible implementation, an overflow groove is disposed along a periphery of the energy director on the second housing, and the overflow groove is configured to accommodate a molten material overflowing after the energy director is melted.

In this way, the molten material formed after the energy director is melted overflows into the overflow groove, thereby resolving a problem that due to an increased interference volume of the energy director, the molten material overflows and an appearance of the second housing is affected.

In a possible implementation, the polymer composite material includes 80-100 wt % of a polymer material and 0-20 wt % of a fiber material.

In this way, the polymer material has excellent performance in terms of mechanical performance, insulation performance, heat insulation performance, and the like. The fiber material can enhance strength of the first housing. Therefore, the polymer composite material formed through combination of the polymer material and the fiber material can ensure that the first housing and the second housing that are prepared have good physical performance.

In a possible implementation, the polymer material is selected from at least one of PA, PC, ABS, or PET, and the fiber material is selected from at least one of glass fiber, aramid fiber, carbon fiber, silicon carbide, or carbon nanotubes.

In a possible implementation, the raw material components of the first housing and the second housing include 77 wt % of the PA, 3 wt % of the glass fiber, and 20 wt % of the hollow sphere material.

In a possible implementation, the raw material components of the first housing and the second housing include 40 wt % of the PA, 10 wt % of the glass fiber, and 50 wt % of the hollow sphere material.

In a possible implementation, the raw material components of the first housing and the second housing include 81 wt % of the PA, 9 wt % of the glass fiber, and 10 wt % of the hollow sphere material. In a possible implementation, the hollow sphere material has a particle diameter of 2-130 μm and a density of 0.2-0.6 g/cm³.

In a possible implementation, the hollow sphere material is selected from at least one of silicon dioxide, aluminum oxide, zirconium oxide, titanium dioxide, ferroferric oxide, zinc oxide, carbon nanotubes, graphene, low-carbon steel, 316 stainless steel, 304 stainless steel, pure iron, or polystyrene.

According to a second aspect, this application further provides an electronic device. The electronic device includes the speaker according to any one of the first aspect.

In this way, compared with an electronic device in a conventional technology, the electronic device that uses the speaker provided in this application can reduce the weight by 7%.

In conclusion, for the speaker and the electronic device provided in this application, to meet a weight reduction requirement, 10-50 wt % of the hollow sphere material is added to the raw material components of the first housing and the second housing, so that the densities of the first housing and the second housing can be reduced, thereby reducing the weights of the first housing and the second housing. In addition, to be compatible with different characteristics of a plurality of types of polymer materials, for example, a crystalline polymer material and a semi-crystalline polymer material, in embodiments of this application, by changing the shape of the energy director, the contact area between the energy director and the first housing is increased. In this way, in the welding process, more energy can be generated, to ensure welding reliability. That is, the speaker provided in the embodiments of this application can meet a reduction requirement of the speaker and can ensure welding reliability.

### BRIEF DESCRIPTION OF THE DRAWINGS

FIG. 1 is a schematic diagram of an overall structure of a speaker according to an embodiment of this application;

FIG. 2 is a schematic diagram of an exploded structure of a speaker according to an embodiment of this application;

FIG. 3A is a sectional view of a speaker in an A1-A1 direction according to an embodiment of this application;

FIG. 3B is a sectional view of a speaker in an A2-A2 direction according to an embodiment of this application;

FIG. 4 is a flowchart of a preparation method for a housing according to an embodiment of this application;

FIG. 5A is a schematic diagram of a structure of a second housing 200 according to an embodiment of this application;

FIG. 5B is a sectional view of a second housing 200 according to an embodiment of this application;

FIG. 6A is a schematic diagram of a structure of another second housing 200 according to an embodiment of this application;

FIG. 6B is a sectional view of another second housing 200 according to an embodiment of this application; and

FIG. 6C is a locally enlarged view of M in FIG. 6B.

### DESCRIPTIONS OF REFERENCE NUMERALS

100—first housing, 110—sound outlet channel, 120—protrusion, 200—second housing, 300—speaker unit, 310—upper surface, 320—lower surface, 400—first cavity, 410—front cavity, 420—rear cavity, 510—energy director, 520—energy director, and 600—overflow groove.

### DETAILED DESCRIPTION OF ILLUSTRATIVE EMBODIMENTS

The following clearly describes the technical solutions in the embodiments of this application with reference to the accompanying drawings in the embodiments of this application. It is clear that the described embodiments are some but not all of the embodiments of this application. Other embodiments obtained by a person of ordinary skill in the art based on the embodiments of this application without creative efforts shall fall within the protection scope of this application.

For ease of understanding, the following first explains and describes English acronyms and related technical terms in the embodiments of this application.

PA: English name Polyamide, Chinese name: Polyamide, also referred to as nylon.

PC: English name Polycarbonate, Chinese name: Polycarbonate.

ABS: English name Acrylonitrile Butadiene Styrene, Chinese name: Acrylonitrile Butadiene Styrene.

PET: English name Polyethylene terephthalate, Chinese name: Polyethylene terephthalate, also referred to as polyester resin.

Currently, electronic devices such as a personal computer, a tablet, and a mobile phone all have a sound playing function, and a component configured to implement the sound playing function is a speaker. Generally, the speaker includes a housing and a speaker unit, where the speaker unit is a core component configured to form an outgoing sound, and the housing is configured to provide a sound cavity for the speaker unit, to implement corresponding acoustic performance. The housing of the speaker is formed by welding two parts of the housing.

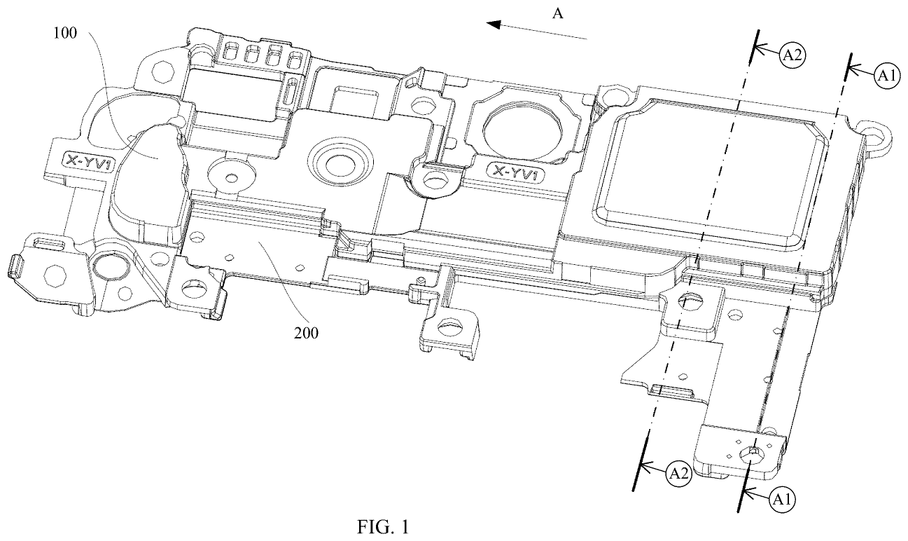

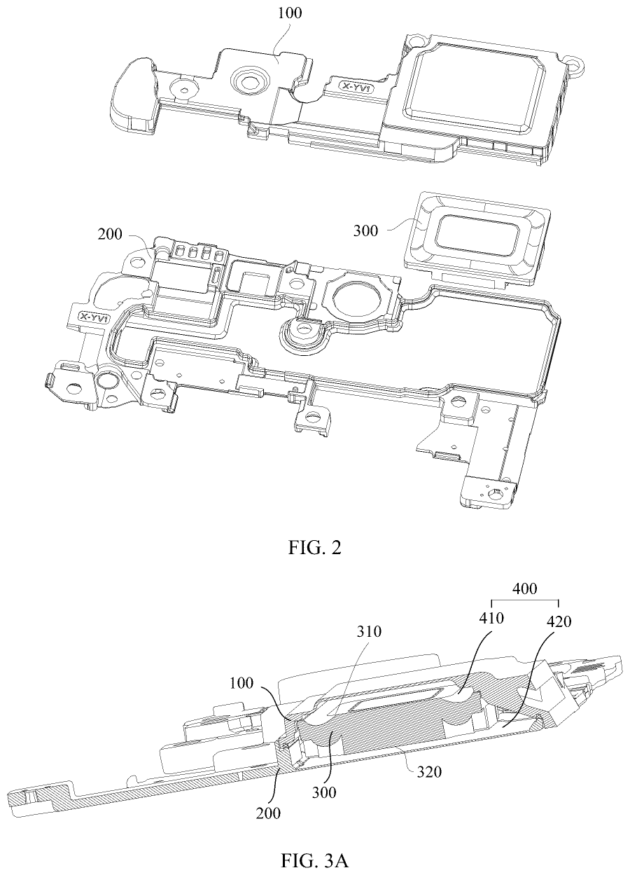

FIG. 1 is a schematic diagram of an overall structure of a speaker according to an embodiment of this application. FIG. 2 is a schematic diagram of an exploded structure of a speaker according to an embodiment of this application. As shown in FIG. 1 and FIG. 2, the speaker includes a first housing 100, a second housing 200, and a speaker unit 300.

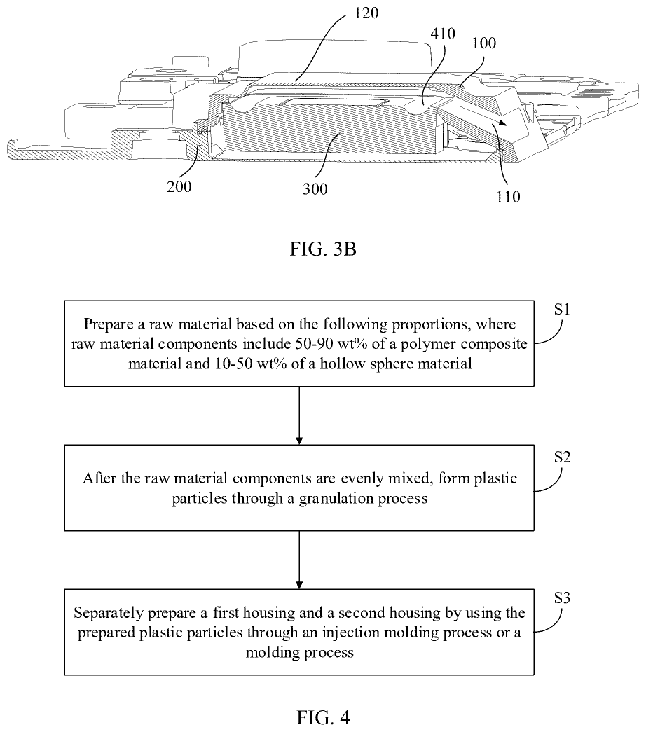

FIG. 3A is a sectional view of a speaker in an A1-A1 direction according to an embodiment of this application. As shown in FIG. 3A, after the first housing 100 is matched with and connected to the second housing 200, a first cavity 400 is formed. The speaker unit 300 is located in the first cavity 400. The speaker unit 300 includes an upper surface 310 facing the first housing 100 and a lower surface 320 facing the second housing. After the speaker unit 300 is matched with and connected to the first housing 100, the first cavity 400 is divided into a front cavity 410 and a rear cavity 420. The upper surface 310 of the speaker unit 300 and the first housing 100 enclose the front cavity 410; and the first housing 100, the second housing 200, the lower surface 320 of the speaker unit 300, and a side surface enclose the rear cavity 420. The speaker unit 300 and the first housing 100 may be bonded and sealed through adhesive dispensing, and the first housing 100 and the second housing 200 may be sealed and connected by welding.

FIG. 3B is a sectional view of a speaker in an A2-A2 direction according to an embodiment of this application. As shown in FIG. 3B, a protrusion 120 protruding in a direction away from the second housing 200 is disposed on the first housing 100, a sound outlet channel 110 is disposed on a side surface of the protrusion 120, and the sound outlet channel 110 is connected to the front cavity 410 but is not connected to the rear cavity 420. In this way, when the speaker unit 300 works, air in the front cavity 410 may be pushed to vibrate, and the air vibrating in the front cavity 410 is exported from the sound outlet channel 110 to form a sound. An arrow direction in FIG. 3B is a sound outlet direction. The sound outlet channel 110 may be connected to a sound outlet hole on a frame of an electronic device. Therefore, the sound may be further exported outside the electronic device, so that the sound can be received by a user.

In this embodiment of this application, the rear cavity 420 is a sealed cavity. Because a sound wave generated by the upper surface 310 of the speaker unit 300 is 180° different from that generated by the lower surface 320, if the rear cavity 420 is an unsealed cavity, the sound wave generated by the upper surface 310 and the sound wave generated by the lower surface 320 enable the sound to disappear due to phase difference interference. Therefore, the rear cavity 420 is designed as a sealed cavity, to cancel the phase difference interference.

As shown in FIG. 3A, a connection region between the first housing 100 and the second housing 200 is located in the rear cavity 420. To meet the acoustic performance requirement, the rear cavity 420 is required to be a sealed cavity. Therefore, in this application, the connection region between the first housing 100 and the second housing 200 is required to be of a sealed connection, to avoid a problem of sound leakage.

Currently, to ensure reliable welding performance, a material of the first housing 100 and a material of the second housing 200 are a polymer composite material composed of PC (polycarbonate) and glass fibers. However, a density of plastic particles formed by the polymer composite material is relatively large, resulting in relatively large mass of the first housing 100 and the second housing 200 that are prepared. Therefore, a requirement for reducing a weight of the electronic device cannot be met.

Therefore, this embodiment of this application provides a speaker. By changing raw material components of the first housing 100 and the second housing 200, a weight of a formed speaker is relatively reduced, and the requirement for reducing the weight of the electronic device is met.

The following describes a housing material provided in this embodiment of this application.

In this embodiment of this application, raw material components of the first housing 100 and those of the second housing 200 are the same. The following uses the first housing 100 as an example to describe the raw material components of the housing.

In this embodiment of this application, the raw material components of the first housing 100 include a polymer composite material and a hollow sphere material. In the raw material components, a mass percentage (wt %) of the polymer composite material in the raw material component is 50-90 wt %, and a mass percentage of the hollow sphere material in the raw material component is 10-50 wt %.

A value of each component described above includes an upper limit value, a lower limit value, and any value between the upper limit value and the lower limit value. For example, the value of the polymer composite material is 50-90 wt %, and specifically includes 50 wt %, 90 wt %, and any value between 50 wt % and 90 wt %. For example, the value of the polymer composite material may be 60 wt %, 65 wt %, 70 wt %, 75 wt %, 80 wt %, or 85 wt %. For another example, the value of the hollow sphere material is 10-50 wt %, and specifically includes 10 wt %, 50 wt %, and any value between 10 wt % and 50 wt %. For example, the value of the hollow sphere material may be 15 wt %, 20 wt %, 25 wt %, 30 wt %, 35 wt %, or 40 wt %.

In this embodiment of this application, the hollow sphere material is added to the raw material components of the first housing 100, so that a density of the first housing 100 can be reduced, thereby reducing a weight of the first housing 100.

In this embodiment of this application, the polymer composite material can ensure that the raw material components have a good processing molding property, and ensure mechanical properties of the first housing 100, such as tensile strength, elongation at break, bending strength, and bending modulus.

In this embodiment of this application, the polymer composite material may use two composite materials: a polymer material and a fiber material. The polymer material has excellent performance in terms of mechanical performance, insulation performance, heat insulation performance, and the like. The fiber material can enhance strength of the first housing 100.

In a specific embodiment, a mass percentage of the polymer material in the polymer composite material is 80-100 wt %, and a mass percentage of the fiber material in the polymer composite material is 0-20 wt %.

A value of each component described above includes an upper limit value, a lower limit value, and any value between the upper limit value and the lower limit value. For example, the value of the polymer material is 80-100 wt %, and specifically includes 80 wt %, 100 wt %, and any value between 80 wt % and 100 wt %. For example, the value of the polymer material may be 85 wt %, 90 wt %, or 95 wt %. For another example, the value of the fiber material is 0-20 wt %, and specifically includes 0 wt %, 20 wt %, and any value between 0 wt % and 20 wt %. For example, the value of the fiber material may be 0.5 wt %, 5 wt %, 10 wt %, or 15 wt %.

Optionally, the polymer material may be selected from at least one of PA, PC, ABS, or PET.

Optionally, the fiber material is selected from at least one of glass fiber, aramid fiber, carbon fiber, silicon carbide, or carbon nanotubes.

In this embodiment of this application, the hollow sphere material is added to the raw material components, to reduce densities of the first housing 100 and the second housing 200, thereby achieving an effect of reducing the weight of the speaker.

Optionally, a diameter of the hollow sphere material particle may be 2-130 μm, and a density of the hollow sphere material may be 0.2-0.6 g/cm³.

In this embodiment of this application, a type of the hollow sphere material is not limited. The hollow sphere material may be selected from any one or more of a ceramic material, a carbon material, a metal material, or a polymer material.

Optionally, the hollow sphere material may be selected from at least one of silicon dioxide, aluminum oxide, zirconium oxide, titanium dioxide, ferroferric oxide, zinc oxide, carbon nanotubes, graphene, low-carbon steel, 316 stainless steel, 304 stainless steel, pure iron, or polystyrene.

It should be noted that, in this embodiment of this application, particle diameters of hollow sphere materials mixed into the raw material components may be the same or may be different. For example, the raw material components include hollow sphere materials of two particle diameters: a particle diameter of one hollow sphere material is 2 μm, and a particle diameter of the other hollow sphere material is 10 μm. For another example, the raw material components include a hollow sphere material of one particle diameter, and the diameter of the hollow sphere material particle is 13 μm.

It should be further noted that, in this embodiment of this application, types of the hollow sphere materials mixed into the raw material components may be the same or may be different. For example, the raw material components include three types of hollow sphere materials. The first type of hollow sphere material is silicon dioxide, the second type of hollow sphere material is carbon nanotubes, and the third type of hollow sphere material is low-carbon steel. For another example, the raw material components include a hollow sphere material of one type, and the type of the hollow sphere material is aluminum oxide.

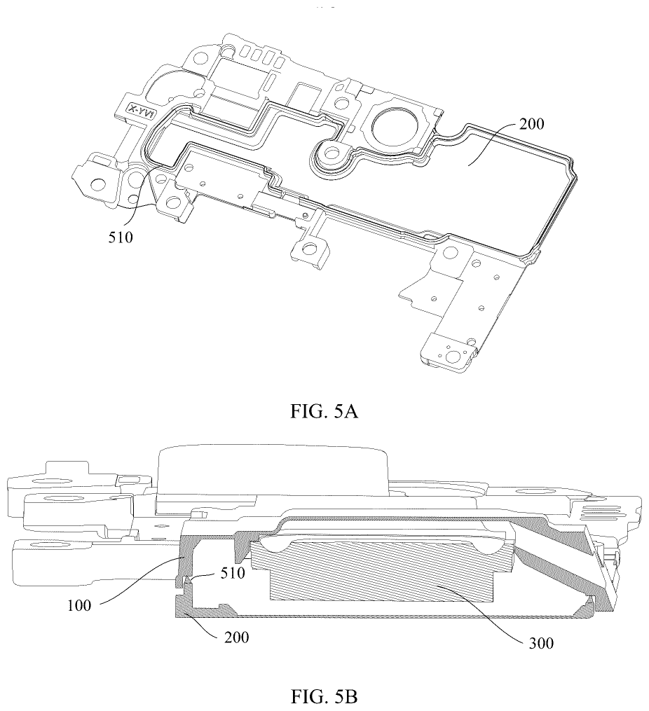

FIG. 4 is a flowchart of a preparation method for a housing according to an embodiment of this application. As shown in FIG. 4, an embodiment of this application provides a preparation method for a housing. The preparation method may include the following steps:

Step S1: Prepare a raw material based on the following proportions, where raw material components include 50-90 wt % of a polymer composite material and 10-50 wt % of a hollow sphere material.

Step S2: After the raw material components are evenly mixed, form plastic particles through a granulation process.

Step S3: Separately prepare a first housing 100 and a second housing 200 by using the prepared plastic particles through an injection molding process or a molding process.

In conclusion, an embodiment of this application further provides a preparation method for a housing. First, raw material components provided in this embodiment of this application are weighed based on proportions, where the raw material components include 50-90 wt % of a polymer composite material and 10-50 wt % of a hollow sphere material. Then, after the raw material components are evenly mixed, plastic particles are formed through a granulation process. Finally, a first housing 100 and a second housing 200 are separately prepared by using the prepared plastic particles through an injection molding process or a molding process. Certainly, after the raw material components are evenly mixed, the first housing 100 and the second housing 200 may be separately directly prepared through the injection molding process or the molding process. This is not limited in this application.

The following are some embodiments of mass percentages of the raw material components provided in this application.

Embodiment 1: In terms of mass percentage, the raw material components for preparing the first housing 100 and the second housing 200 include: 77 wt % of PA, 3 wt % of glass fiber, and 20 wt % of a hollow sphere material.

Embodiment 2: In terms of mass percentage, the raw material components for preparing the first housing 100 and the second housing 200 include: 40 wt % of PA, 10 wt % of glass fiber, and 50 wt % of a hollow sphere material.

Embodiment 3: In terms of mass percentage, the raw material components for preparing the first housing 100 and the second housing 200 include: 81 wt % of PA, 9 wt % of glass fiber, and 10 wt % of a hollow sphere material.

To illustrate that the raw material components of the first housing 100 and the second housing 200 in this application are conducive to weight reduction, and have good physical performance such as tensile strength, elongation at break, bending strength, and bending modulus, the first housing 100 and the second housing 200 are prepared based on component proportions shown in Embodiment 1-Embodiment 3 and a comparative example in Table 1, according to the preparation method for a housing provided above. The raw material components of the first housing 100 and the second housing 200 are the same, and performance of the prepared first housing 100 and that of the prepared second housing 200 are also the same. Therefore, a performance test is performed on only the prepared first housing 100 in this application. For a test result of the performance test performed on the first housing 100, refer to Table 1.

TABLE 1
Performance test results of the first housing 100

| | Raw material | | | | | |
|---|---|---|---|---|---|---|
| | components | | Tensile | | Bending | Bending |
| | (mass | Density | strength | Elongation | strength | modulus |
| | percentage) | (g/cm³) | (MPa) | at break (%) | (MPa) | (MPa) |
| Comparative | 80% PC + 20% | 1.34 | 100 | 2 | 125 | 5500 |
| example 1 | glass fiber | | | | | |
| Embodiment 1 | 77% PA + 3% | 0.98 | 95 | 4.5 | 120 | 3900 |
| | glass | | | | | |
| | fiber + 20% | | | | | |
| | hollow sphere | | | | | |
| | material | | | | | |
| Embodiment 2 | 40% PA + 10% | 0.88 | 80 | 1.8 | 105 | 8800 |
| | glass | | | | | |
| | fiber + 50% | | | | | |
| | hollow sphere | | | | | |
| | material | | | | | |
| Embodiment 3 | 81% PA + 9% | 1.12 | 100 | 3.5 | 125 | 4170 |
| | glass | | | | | |
| | fiber + 10% | | | | | |
| | hollow sphere | | | | | |
| | material | | | | | |

As shown in Table 1, the density of the first housing 100 prepared based on the proportions of the raw material components in Embodiment 1 to Embodiment 3 is less than that of the first housing 100 prepared based on the proportions of the raw material components in the comparative example 1. That is, in this embodiment of this application, the hollow sphere material may be added to the raw material components, to reduce the weight of the prepared first housing 100. Specifically, the weight of the first housing 100 prepared according to Embodiment 1 may be reduced by 27% relative to that of the first housing prepared according to the comparative example 1. The weight of the entire electronic device using the first housing and the second housing that are prepared according to Embodiment 1 may be reduced by 7% relative to that of the entire electronic device using the first housing 100 and the second housing 200 that are prepared according to the comparative example 1.

Continue to refer to Table 1. The first housing 100 prepared based on the proportions of the raw material components in Embodiment 1 to Embodiment 3 has good physical performance such as tensile strength, elongation at break, bending strength, and bending modulus. In this way, the prepared first housing 100 can meet a requirement for application in the electronic device.

As shown in FIG. 3A, the connection region between the first housing 100 and the second housing 200 is located in the rear cavity 420. To meet the acoustic performance requirement, the rear cavity 420 is required to be a sealed cavity. Therefore, in this application, the connection region between the first housing 100 and the second housing 200 is required to be of a sealed connection, to avoid a problem of sound leakage.

A specific manner for the sealed connection between the first housing 100 and the second housing 200 is not limited during implementation of this application. For example, the first housing 100 and the second housing 200 may be connected by welding, such as ultrasonic welding, hot air welding, or hot plate welding. Ultrasonic welding is used as an example. Ultrasonic welding means melting a material at a joint by using high-frequency vibration energy, and then cooling and solidifying the molten material, to connect the first housing 100 to the second housing 200.

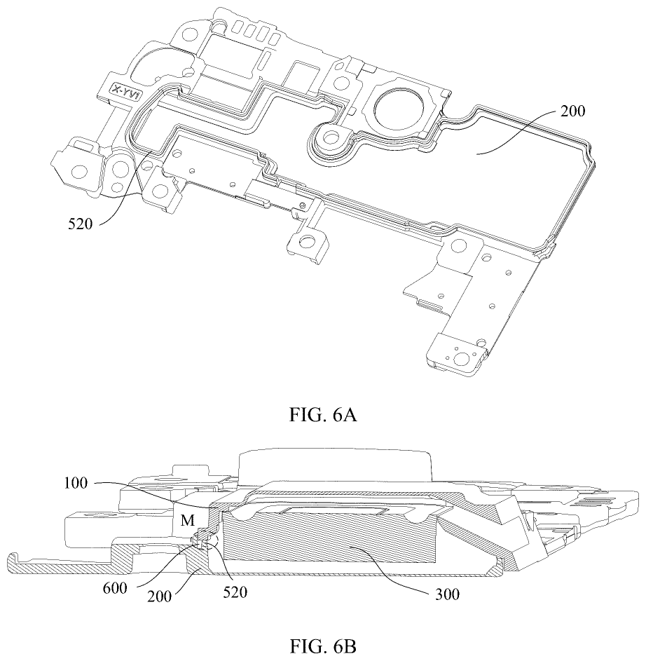

FIG. 5A is a schematic diagram of a structure of a second housing 200 according to an embodiment of this application.

FIG. 5B is a sectional view of a second housing 200 according to an embodiment of this application.

As shown in FIG. 5A and FIG. 5B, in a possible implementation, to enhance welding strength, an energy director 510 is pre-disposed on a first housing 100 or the second housing 200 when the first housing 100 and the second housing 200 are connected by using ultrasonic welding. In this way, the first housing 100 and the second housing 200 may be connected by melting the energy director. The energy director 510 may be disposed in a region that is at an edge of the second housing 200 and that is used to connect to the first housing 100, and is an annular distribution closed around the edge of the second housing 200.

As shown in FIG. 5B, a cross section of the energy director 510 is triangular, and a width of the cross section of the energy director gradually decreases in a direction of approaching the first housing 100. In this way, when the first housing 100 and the second housing 200 are connected by using the energy director 510, the energy director 510 on the second housing 200 is in contact alignment with a connection position corresponding to the first housing 100, and after the contact alignment, the energy director 510 on the second housing 200 and the first housing 100 form a line contact. In an ultrasonic welding process, the second housing 200 is subjected to high-frequency vibration energy, and the energy director 510 and the first housing 100 generate heat by rubbing against each other to melt a material, and then are welded together.

It should be noted that the triangular energy director 510 is mainly applicable to a case in which raw material components include a crystalline polymer material. For example, the raw material components of the first housing 100 and the second housing 200 include PC. Because PC is a crystalline material, energy required by PC in the ultrasonic welding process is relatively small. In this way, even if the triangular energy director 510 is used, welding reliability can be ensured.

However, if the raw material components of the first housing 100 and the second housing 200 include a semi-crystalline polymer material such as PA, the semi-crystalline polymer material needs more energy than the crystalline polymer material in the ultrasonic welding process. If the triangular energy director 510 is still used, because the triangular energy director 510 is in a line contact with the first housing 100, and a contact area is small, a welding crack may occur, which causes a gas leakage problem.

To resolve a problem that a welding crack may occur after welding of the semi-crystalline polymer material, a structure of the energy director 510 is further improved in this application.

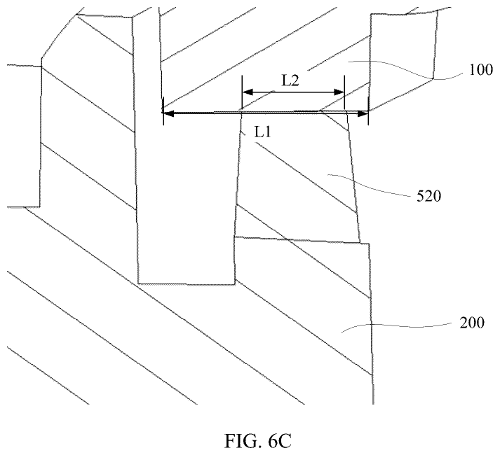

FIG. 6A is a schematic diagram of a structure of another second housing 200 according to an embodiment of this application.

FIG. 6B is a sectional view of another second housing 200 according to an embodiment of this application.

As shown in FIG. 6A and FIG. 6B, in another possible implementation, a circle of frustum-shaped energy director 520 is disposed in a region that is of the second housing 200 and that is used to connect to the first housing 100.

As shown in FIG. 6B, a cross section of the energy director 520 is trapezoidal, and a width of the cross section of the energy director gradually decreases in a direction of approaching the first housing 100. In this way, when the first housing 100 and the second housing 200 are connected by using the energy director 520, the energy director 520 on the second housing 200 is in contact alignment with a connection position corresponding to the first housing 100, and after the contact alignment, the energy director 510 on the second housing 200 and the first housing 100 form a surface contact. In an ultrasonic welding process, the second housing 200 is subjected to high-frequency vibration energy, and the energy director 520 and the first housing 100 are in full contact and generate heat by rubbing against each other, and then are welded together.

In this embodiment of this application, an energy director 510 with a triangular cross section is improved to the energy director 520 with a trapezoidal cross section, to increase a contact area between the energy director 510 and the first housing 100. In this way, a rubbing area between the energy director 520 and the first housing 100 may be increased in a welding process, thereby generating more energy, to ensure welding reliability.

FIG. 6C is a locally enlarged view of M in FIG. 6B. As shown in FIG. 6C, a width of a region that is in the first housing 100 and that is used to connect to the second housing 200 is L1, and a width of contact between the energy director 520 and the first housing 100 is L2. To generate more energy in a welding process and ensure welding reliability, the width L2 may be designed to 10%-100% of the width L1.

In this embodiment of this application, roughening processing may be further performed on an outer surface of the energy director 510 or the energy director 520, to increase roughness of the outer surface of the energy director 510 or the energy director 520. In this way, the energy director 510 or the energy director 520 with increased surface roughness is more conducive to generating heat by rubbing against the first housing 100, and then is welded together with the first housing.

It should be noted that a surface roughening processing manner is not limited in this application. For example, a concave-convex texture may be disposed on the outer surface of the energy director 510 or the energy director 520. For another example, concave-convex particles may be disposed on the outer surface of the energy director 510 or the energy director 520.

As shown in FIG. 5B and FIG. 6B, an interference volume of the trapezoidal energy director 520 is increased compared with that of the triangular energy director 510. In this way, a molten material formed after the energy director is melted easily overflows to a surface of the second housing 200, and affects an appearance of the second housing 200. Therefore, as shown in FIG. 6B, in this application, an overflow groove 600 is disposed along a periphery of the energy director 520 on the second housing 200. In this way, the molten material formed after the energy director 520 is melted overflows into the overflow groove 600, thereby resolving a problem that due to the increased interference volume of the energy director 520, the molten material overflows and the appearance of the second housing 200 is affected.

It should be noted that, in the above embodiment, only the energy director 520 with a trapezoidal cross section is used as an example for description, which does not indicate a limitation on a structure of the energy director 520, provided that a contact area between the energy director 520 and the first housing 100 is increased. For example, the cross section of the energy director 520 in this embodiment of this application may be rectangular, W-shaped, or another regular or irregular shape.

In conclusion, for the speaker provided in the embodiments of this application, to meet the weight reduction requirement, 10-50 wt % of the hollow sphere material is added to the raw material components of the first housing 100 and the second housing 200, so that the densities of the first housing 100 and the second housing 200 can be reduced, thereby reducing the weights of the first housing 100 and the second housing 200. In addition, to be compatible with different characteristics of a plurality of types of polymer materials, for example, a crystalline polymer material and a semi-crystalline polymer material, in the embodiments of this application, by changing the shape of the energy director, the contact area between the energy director and the first housing 100 is increased. In this way, in the welding process, more energy can be generated, to ensure welding reliability. That is, the speaker provided in the embodiments of this application can meet a reduction requirement of the speaker and can ensure welding reliability.

An embodiment of this application further provides an electronic device. The electronic device includes the speaker provided in the embodiments of this application. The electronic device in this embodiment of this application may be any terminal device that has a speaker, such as a personal computer, a tablet, a mobile phone, a band, or a watch.

In the descriptions of this application, it should be noted that an orientation relationship or a position relationship indicated by terms “upper”, “lower”, “inside”, “outside”, “front”, “rear”, “left”, and “right” is an orientation relationship or a position relationship based on an operating state of this application, and is merely for ease of describing this application and simplifying the description, rather than indicating or implying that a specified apparatus or element necessarily has a specific orientation or is constructed and operated in a specific orientation. Therefore, the terms should not be construed as a limitation on this application.

It should be additionally noted that the relational terms herein such as first and second are used only to differentiate an entity or operation from another entity or operation, and do not require or imply any actual relationship or sequence between these entities or operations. The term “include”, “comprise”, or any other variant thereof is intended to cover non-exclusive inclusion, so that a process, method, article, or device that includes a series of elements includes not only those elements but also other elements that are not expressly listed, or includes elements inherent to such a process, method, article, or device.

A person skilled in the art can easily figure out another implementation solution of this application after considering this specification and practicing this application that is disclosed herein. This application is intended to cover any variations, functions, or adaptive changes of this application. These variations, functions, or adaptive changes comply with general principles of this application, and include common knowledge or a commonly used technical means in the art that is not disclosed in this application. This specification and the embodiments are merely considered as examples, and the actual scope and spirit of this application are pointed out by the following claims.

It should be understood that this application is not limited to the precise structures described above and shown in the accompanying drawings, and various modifications and changes may be made without departing from the scope thereof.

The scope of this application is limited only by the appended claims.

1-13. (canceled)

14. A speaker, comprising:
a speaker unit, a first housing and a second housing, an energy director is disposed on the first housing or the second housing, wherein
raw material components of the second housing and the first housing comprise: a polymer composite material and a hollow sphere material; the polymer composite material comprises polyamide PA, a range of a mass percentage of the PA in the polymer composite material is 80-100 wt %, a range of a diameter of the hollow sphere material particle is 2-130 μm, a range of a mass percentage of the hollow sphere material in the raw material components is 10-50 wt %, and a range of a mass percentage of the polymer composite material in the raw material components is no less than 50 wt %;
the energy director melts after being welded to connect the first housing and the second housing together, wherein an overflow groove is disposed on a side of the energy director, and the overflow groove is configured to accommodate a molten material overflowing after being melted; and
the speaker unit is disposed between the first housing and the second housing, the speaker unit connects with the first housing adhesively to form a front cavity on a first side of the speaker unit, a sound outlet channel is disposed on the first housing, the front cavity is connected to the sound outlet channel, the speaker unit is configured to drive air in the front cavity to vibrate, and the air vibrating in the front cavity is directed out through the sound outlet channel; and
a rear cavity is disposed on a second side of the speaker unit based on the first housing, the second housing and the speaker unit, the rear cavity is a sealed cavity.

15. The speaker according to claim 14, wherein the range of a mass percentage of the polymer composite material in the raw material components is 50-90 wt %.

16. The speaker according to claim 15, wherein the mass percentage of the polymer composite material in the raw material components is one of 60 wt %, 65 wt %, 70 wt %, 75 wt %, 80 wt %, and 85 wt %.

17. The speaker according to claim 15, wherein the mass percentage of the hollow sphere material in the raw material components is one of 15 wt %, 20 wt %, 25 wt %, 30 wt %, 35 wt %, and 40 wt %.

18. The speaker according to claim 14, wherein a mass percentage of the PA in the raw material components is 77 wt %, and the mass percentage of the hollow sphere material in the raw material components is 20 wt %.

19. The speaker according to claim 14, wherein a mass percentage of the PA in the raw material components is 40 wt %, and the mass percentage of the hollow sphere material in the raw material components is 50 wt %.

20. The speaker according to claim 14, wherein a mass percentage of the PA in the raw material components is 81 wt %, and the mass percentage of the hollow sphere material in the raw material components is 10 wt %.

21. The speaker according to claim 14, wherein the hollow sphere material comprises silicon dioxide.

22. The speaker according to claim 21, wherein a range of a density of the hollow sphere material is 0.2-0.6 g/cm³.

23. The speaker according to claim 14, wherein the overflow groove is located on a side, of the energy director, away from the speaker unit.

24. The speaker according to claim 14, wherein the polymer composite material further comprises a fiber material.

25. The speaker according to claim 24, wherein the fiber material comprises at least one of glass fiber, aramid fiber, carbon fiber, silicon carbide, or carbon nanotubes.

26. The speaker according to claim 14, wherein a cross section of the energy director is trapezoidal, rectangular, or W-shaped.

27. An electronic device, wherein the electronic device comprises the speaker, and the speaker comprises:
a speaker unit, a first housing and a second housing, an energy director is disposed on the first housing or the second housing, wherein
raw material components of the second housing and the first housing comprise: a polymer composite material and a hollow sphere material; the polymer composite material comprises polyamide PA, a range of a mass percentage of the PA in the polymer composite material is 80-100 wt %, a range of a diameter of the hollow sphere material particle is 2-130 μm, a range of a mass percentage of the hollow sphere material in the raw material components is 10-50 wt %, and a range of a mass percentage of the polymer composite material in the raw material components is no less than 50 wt %;
the energy director melts after being welded to connect the first housing and the second housing together, wherein an overflow groove is disposed on a side of the energy director, and the overflow groove is configured to accommodate a molten material overflowing after being melted; and
the speaker unit is disposed between the first housing and the second housing, the speaker unit connects with the first housing adhesively to form a front cavity on a first side of the speaker unit, a sound outlet channel is disposed on the first housing, the front cavity is connected to the sound outlet channel, the speaker unit is configured to drive air in the front cavity to vibrate, and the air vibrating in the front cavity is directed out through the sound outlet channel; and
a rear cavity is disposed on a second side of the speaker unit based on the first housing, the second housing and the speaker unit, the rear cavity is a sealed cavity.

28. The electronic device according to claim 27, wherein the electronic device is one of a personal computer, a tablet, or a mobile phone.

29. The electronic device according to claim 27, wherein the range of a mass percentage of the polymer composite material in the raw material components is 50-90 wt %.

30. The electronic device according to claim 27, wherein the hollow sphere material comprises silicon dioxide.

31. The electronic device according to claim 30, wherein a range of a density of the hollow sphere material is 0.2-0.6 g/cm³.

32. The electronic device according to claim 27, wherein the overflow groove is located on a side, of the energy director, away from the speaker unit.

33. The electronic device according to claim 27, wherein the polymer composite material further comprises a fiber material, and the fiber material comprises at least one of glass fiber, aramid fiber, carbon fiber, silicon carbide, or carbon nanotubes.
